(19) United States
(12) Patent Application Publication
(10) Pub. No.: US 2018/0365469 A1
(43) Pub. Date: Dec. 20, 2018

(54) Optical Fingerprint Module

(71) Applicant: Shanghai Oxi Technology Co., Ltd, Shanghai (CN)

(72) Inventors: Yan Ling, Shanghai (CN); Hong Zhu, Shanghai (CN)

(21) Appl. No.: 15/752,972

(22) PCT Filed: Aug. 18, 2016
(86) PCT No.: PCT/CN2016/095844

§ 371 Date: Feb. 15, 2018

(30) Foreign Application Priority Data
Jul. 8, 2016 (CN) 201610537307.4

(51) Int. Cl. G06K 9/00

(52) U.S. Cl. CPC G06K 9/0004; G06K 9/00046

(57) ABSTRACT

Provided is an optical fingerprint module which comprises an optical fingerprint sensor and a point-shaped backlight source. The optical fingerprint sensor has only one non-opaque substrate. A first surface of the non-opaque substrate is in direct contact with a fingerprint. A device layer is arranged at a second surface of the non-opaque substrate and has a pixel region comprising multiple pixels. Each pixel has a non-opaque region and a light blocking region. A photosensitive device is arranged at the light blocking region. The non-opaque region allows light to pass through the pixel region of the device layer. The point-shaped backlight source is located right below the pixel region. The point-shaped backlight source and the optical fingerprint sensor are spaced apart from each other. A right or approximate right angle is formed between light emitted by the point-shaped backlight source and the first surface of the non-opaque substrate.

### CROSS-REFERENCE TO RELATED APPLICATIONS

The present application claims the benefit of priority to Chinese Patent Application No. 201610537307.4, filed on Jul. 8, 2016, and entitled “OPTICAL FINGERPRINT SENSOR MODULE”, the entire disclosures of which are incorporated herein by reference.

### TECHNICAL FIELD

The present disclosure generally relates to optical fingerprint identification field, and more particularly, to an optical fingerprint module.

### BACKGROUND

Fingerprint imaging recognition technology is used to realize identification by capturing fingerprint images of a person using optical fingerprint sensors or modules and then determining whether the fingerprint image information matches that already stored in a system. Due to its convenience in use and uniqueness of human fingerprints, the fingerprint recognition technology has been widely applied to various fields, such as security inspection field including Public Security Bureau (PSB) or the like, access control systems of buildings, consumption goods field including personal computers or mobile phones etc., and the like. The fingerprint recognition technology may be realized by optical imaging, capacitance imaging, ultrasound imaging and so on, among which, the optical fingerprint recognition technology is advantageous in the imaging quality and device cost.

More information on optical fingerprint modules can refer to the Chinese Utility Model Patent with a publication No. CN203405831U.

However, structures and performance of the existing optical fingerprint modules still remain to be improved.

An optical fingerprint module is provided according to embodiments of the present disclosure to optimize structures of existing optical fingerprint modules and improve performance of the existing optical fingerprint modules.

In some embodiments, the optical fingerprint module may include: an optical fingerprint sensor; and a point-shaped backlight source; wherein the optical fingerprint sensor includes only one non-opaque substrate; a first surface of the non-opaque substrate is directly used for fingerprinting contact; a device layer is disposed on a second surface of the non-opaque substrate; the device layer includes a pixel region, the pixel region includes a plurality of pixels, each of the plurality of pixels includes a non-opaque region and a light blocking region, the light blocking region includes a photosensitive device, and the non-opaque region allows light to pass through the pixel region of the device layer; and the point-shaped backlight source is disposed right under the pixel region, the point-shaped backlight source and the optical fingerprint sensor are disposed with an interval, and a right angle or a near-right angle is formed between light emitted from the point-shaped backlight source and the first surface of the non-opaque substrate.

In some embodiments, the point-shaped backlight source is disposed under the device layer, and an output light of the point-shaped backlight source passes through the device layer from the non-opaque region and then enters the non-opaque substrate.

In some embodiments, each of the plurality of pixels further includes a light blocking layer, the photosensitive device is disposed between the light blocking layer and the non-opaque substrate, and the light blocking layer is disposed between the photosensitive device and the point-shaped backlight source.

In some embodiments, the point-shaped backlight source includes at least one Light Emitting Diode (LED) light, light of the at least one LED light is near ultraviolet light, purple light, blue light, green light, yellow light, red light, near infrared light or white light; or, the point-shaped backlight source includes two or more LED lights, the two or more LED lights are symmetrically distributed under the optical fingerprint sensor, and light of the two or more LED lights is near-ultraviolet light, purple light, blue light, green light, yellow light, red light, near infrared light or white light.

In some embodiments, the optical fingerprint module may further include a light focusing lens disposed in front of a light emitting surface of the point-shaped backlight source, wherein the light focusing lens is configured to convert light of the point-shaped backlight source into parallel light or near-parallel light, and the light emitted from the point-shaped backlight source enters the light focusing lens and then enters the optical fingerprint sensor.

In some embodiments, the optical fingerprint module may further include a light anti-reflection layer disposed on a surface of the device layer and configured to increase a proportion of light emitted from the point-shaped backlight source which enters the optical fingerprint sensor.

In some embodiments, the optical fingerprint module may further include a non-opaque dielectric layer disposed between the optical fingerprint sensor and the point-shaped backlight source, wherein light emitted from the point-shaped backlight source enters the non-opaque dielectric layer and then enters the optical fingerprint sensor.

In some embodiments, a lower surface of the non-opaque dielectric layer is a light focusing surface, the light emitted from the point-shaped backlight source enters the non-opaque dielectric layer from the light focusing surface, and the light focusing surface is configured to convert the light emitted from the point-shaped backlight source into parallel light or near-parallel light.

In some embodiments, the optical fingerprint module may further include a light anti-reflection layer disposed on the lower surface of the non-opaque dielectric layer and configured to increase a proportion of the light emitted from the point-shaped backlight source which enters the non-opaque dielectric layer.

In some embodiments, the non-opaque dielectric layer is made of glass, plastic or optical adhesive; and the light focusing surface of the non-opaque dielectric layer is an oblique surface, a spherical crown surface, an ellipsoidal crown surface, a conical side surface or a pyramid side surface.

In some embodiments, the non-opaque dielectric layer has a refraction index above 1.2.

In some embodiments, the optical fingerprint module may further include a light filtering layer disposed on at least one of the first surface and the second surface of the non-opaque substrate.

Compared with the prior art, the present disclosure has the following advantages.

In the optical fingerprint module according to embodiments, the optical fingerprint sensor may include only one non-opaque substrate, thus the light emitted by the point-shaped backlight source only needs to pass through the device layer and the one non-opaque substrate when passing through the optical fingerprint sensor. Therefore, number of substrates the light passes through can be reduced, which is advantageous to form clear fingerprint images; and the optical fingerprint sensor has a simple structure and a reduced thickness, which can simplify the structure of the optical fingerprint module and reduce the cost. In addition, the point-shaped backlight source and the optical fingerprint sensor are disposed with an interval, and a right angle or a near-right angle is formed between the light emitted by the point-shaped backlight source and the first surface of the non-opaque substrate, the light reaching the first surface can be mostly reflected with a small offset (or zero offset) at an interface between the first surface and a finger, and most of the effectively reflected light irradiates to pixels closer to corresponding reflection points in the pixel region. Therefore, using the optical fingerprint module without a light guiding plate, accurate fingerprint image recognition can be achieved, definition of the fingerprint images can be improved, a structure of the optical fingerprint module can be simplified and cost can be reduced.

Further, the point-shaped backlight source may include two LED lights. During fingerprint image capturing, any one of the two LED lights may be selected as an imaging light source of a fingerprint image, or light emitted from the two LED lights may be used in turn for imaging, and afterward, calculations like noise reduction and compensation and so on are performed, so as to obtain a fingerprint image with higher definition and higher accuracy, and further to improve performance of the optical fingerprint module.

Further, a light focusing lens is disposed in front of a light emitting surface of the point-shaped backlight source and configured to convert the light emitted from the point-shaped backlight source into parallel light or near-parallel light. The light emitted from the point-shaped backlight source enters the light focusing lens, and then enters the optical fingerprint sensor. Therefore, parallel light or the near-parallel light may be used to capture fingerprint images, so as to obtain the fingerprint images with less distortion and higher accuracy and to improve performance of the optical fingerprint module.

Further, a non-opaque dielectric layer having a refraction index greater than air may be disposed between the optical fingerprint sensor and the point-shaped backlight source. Light is allowed to enter the non-opaque dielectric layer from a lower surface of the non-opaque dielectric layer, and the lower surface of the non-opaque dielectric layer may serve as a light focusing surface which can convert light of the point-shaped backlight source into parallel light or near-parallel light. The light emitted from the point-shaped backlight source enters the non-opaque dielectric layer from the light focusing surface, and then enters the optical fingerprint sensor. Therefore, parallel light or the near-parallel light may be used to capture fingerprint images, so as to obtain the fingerprint images with less distortion and higher accuracy and to improve performance of the optical fingerprint module.

Further, a light anti-reflection layer may be disposed on the lower surface of the non-opaque dielectric layer, and the light anti-reflection layer can increase a proportion of the light emitted from the backlight source which enters the non-opaque dielectric layer. Therefore, fingerprint images may be captured using more light, so that the fingerprint images with higher definition and higher accuracy can be obtained, and performance of the optical fingerprint module can be further improved.

### BRIEF DESCRIPTION OF THE DRAWINGS

FIG. 1 schematically illustrates a top view of an optical fingerprint sensor and a point-shaped backlight source in an optical fingerprint module according to an embodiment;

FIG. 2 schematically illustrates a cross-sectional view of the optical fingerprint module shown in FIG. 1;

FIG. 3 schematically illustrates a cross-sectional view of an optical fingerprint module according to another embodiment:

FIG. 4 schematically illustrates a cross-sectional view of an optical fingerprint module according to another embodiment;

FIG. 5 schematically illustrates a cross-sectional view of an optical fingerprint module according to another embodiment;

FIG. 6 schematically illustrates a cross-sectional view of an optical fingerprint module according to another embodiment;

FIG. 7 schematically illustrates a cross-sectional view of an optical fingerprint module according to another embodiment; and

FIG. 8 schematically illustrates a cross-sectional view of an optical fingerprint module according to another embodiment.

### DETAILED DESCRIPTION

An existing optical fingerprint sensor normally includes a non-opaque substrate and a protective layer, which may inevitably result in a thickness of the entire optical fingerprint sensor become larger. The larger thickness may induce light emitted from a light source to pass through a longer optical path before reaching a photosensitive device, which may have negative effects on improvement of quality of the captured fingerprint image.

In view of above, an optical fingerprint module is provided in the present disclosure, which omits the protective layer and simplifies a structure of the optical fingerprint sensor, thereby not only reducing a thickness of the optical fingerprint module but also improving quality of the captured fingerprint image.

The foregoing objects, features and advantages of the present disclosure will become more apparent from the following detailed description of specific embodiments in conjunction with the accompanying drawings.

An optical fingerprint module is provided according to an embodiment of the present disclosure.

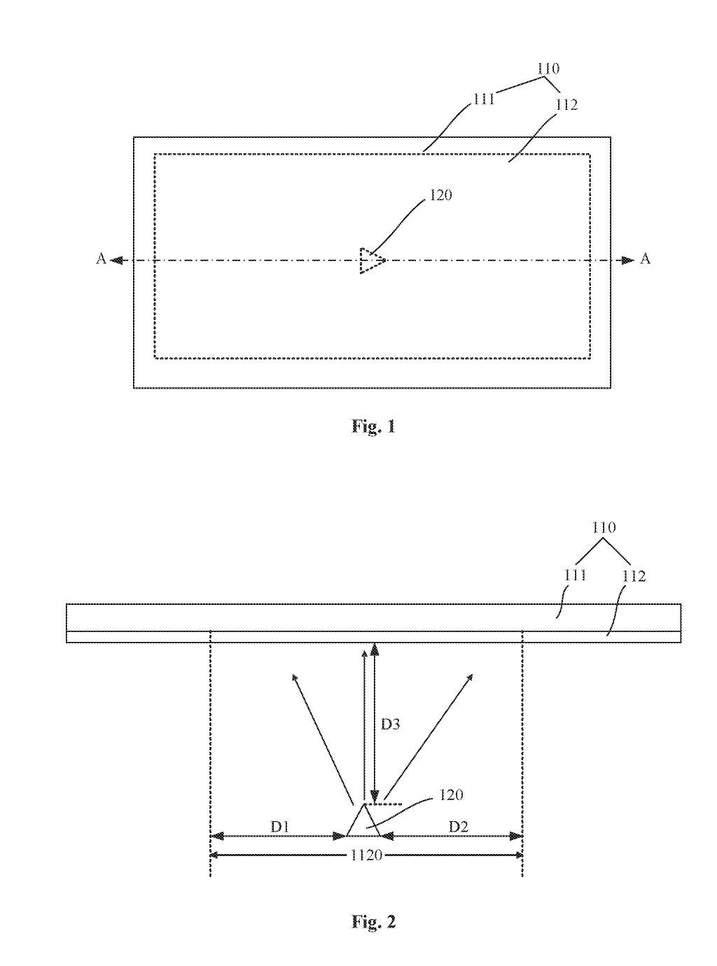

With reference to FIGS. 1 and 2. FIG. 1 schematically illustrates a top view of an optical fingerprint module according to an embodiment (the dotted line in FIG. 1 represents a structure located on a lower layer, and reference may be also made to FIG. 2). FIG. 2 schematically illustrates a cross-sectional view of the optical fingerprint module along an A-A line shown in FIG. 1.

Referring to FIGS. 1 and 2, the optical fingerprint module may include an optical fingerprint sensor 110 and a point-shaped backlight source 120.

In some embodiment, the optical fingerprint sensor 110 may include only one non-opaque substrate 111. A first surface (not shown) of the non-opaque substrate 111 may be directly used for fingerprint contact, and the optical fingerprint sensor 110 may further include a device layer 112 disposed on a second surface (not shown) of the non-opaque substrate 111. Specifically, as shown in FIG. 2, the first surface may be an upper surface of the non-opaque substrate 111, and the second surface may be a lower surface of the non-opaque substrate 111.

In some embodiment, the non-opaque substrate 111 may have a thickness equal to or less than 5 cm. The non-opaque substrate 111 may be made of glass, plastic or the like.

Referring to FIG. 2, the device layer 112 may include a pixel region 1120 labeled between two long dashed lines. A region between the two long dashed lines under the pixel region 1120 is right under the pixel region 1120. It should be noted that, in the cross-sectional views of the optical fingerprint modules according to other embodiments in the present disclosure, a pixel region is labeled as the same way.

In some embodiment, the pixel region 1120 may be rectangle-shaped (not shown), and each side length of the pixel region 1120 may be selected according to product requirements.

In some embodiment, the pixel region 1120 may include a plurality of pixels (not shown) arranged in a matrix of rows and columns, and corresponding data lines (not shown) and scanning lines (not shown) may be disposed between the rows and columns of pixels. Specifically, a plurality of scanning lines may be disposed along a first axial direction, a plurality of data lines may be disposed along a second axial direction, the plurality of scanning lines and the plurality of data lines may define a plurality of grids, and the plurality of pixels may be disposed in the plurality of grids. Each of the plurality of pixels may be rectangle-shaped, and each side length of the rectangle may be less than or equal to 100 μm.

In some embodiment, each of the plurality of pixels may include a non-opaque region (not shown) and a light blocking region (not shown), where the light blocking region may include a photosensitive device (not shown), and the non-opaque region allows light to pass through the pixel region 1120 of the device layer 112.

It should be noted that, in the device layer 112, a non-opaque structure may also be disposed in regions surrounded the pixel region 1120. In some embodiments, regions other than the pixel region 1120 may be provided with a non-opaque structure on the basis of ensuring a corresponding structure and a corresponding function. For example, a structure such as a driving circuit and a bonding pin may be formed in the regions surrounded the pixel region 1120 so as to achieve functions like driving and bonding and so on.

Referring to FIG. 2, the point-shaped backlight source 120 may be disposed right under the pixel region 1120, the point-shaped backlight source 120 and the optical fingerprint sensor 110 may be disposed with an interval referred to as a third distance D3, and a right angle or a near-right angle may be formed between light emitted from the point-shaped backlight source 120 and the first surface of the non-opaque substrate 111, where the near-right angle may range from 85° to 90°.

In some embodiment, the point-shaped backlight source 120 may be disposed below the device layer 112, and light emitted from the point-shaped backlight source 120 may pass through the device layer 112 from the non-opaque region and then enter the non-opaque substrate 111.

In some embodiment, the point-shaped backlight source 120 may be a Light Emitting Diode (LED) light. Light emitted from the LED light may be near ultraviolet light, purple light, blue light, green light, yellow light, red light, near infrared light or white light.

Referring to FIG. 2, the light emitted from the point-shaped backlight source 120 is shown by black unidirectional arrows. In the cross-sectional view shown in FIG. 2, in a horizontal direction, there is a first distance D1 between a left edge of a region right under the pixel region 1120 and the point-shaped backlight source 120, and a second distance D2 between a right edge of the region right under the pixel region 1120 and the point-shaped backlight source 120. In a vertical direction, there is a third distance D3 between the point-shaped backlight source 120 and the optical fingerprint sensor 110.

From above, it can be seen that, due to existence of the first distance D1, the second distance D2 and the third distance D3, the point-shaped backlight source 120 may be necessarily located right under the pixel region 1120.

In some embodiment, the point-shaped backlight source 120 may be placed in an appropriate position by adjusting the first distance D1, the second distance D2 and the third distance D3, so as to improve definition of fingerprint images captured by the optical fingerprint module.

In some embodiment, each of the plurality of pixels may further include a light blocking layer, the photosensitive device is disposed between the light blocking layer and the non-opaque substrate 111, and the light blocking layer is disposed between the photosensitive device and the point-shaped backlight source 120. Since the light blocking layer is disposed at a certain position, the photosensitive device can only receive optical signals entering the device layer 110 from the non-opaque substrate 111, and the light emitted from the point-shaped backlight source 120 cannot directly irradiate to the photosensitive device from an underneath of the device layer 110.

In other embodiments, a light filtering layer may be disposed on at least one of the first surface and the second surface of the non-opaque substrate. The light filtering layer may include at least one of an interference reflection layer and a light absorption layer, where the interference reflection layer may increase a difference between reflected light at a position with a finger and reflected light at a position without finger, thereby increasing image contrast and reducing interference of an ambient light on a fingerprint image, and further reducing an influence of ambient light on the fingerprint imaging.

In other embodiments, the point-shaped backlight source may include two or more LED lights, the two or more LED lights may be symmetrically and evenly distributed under the optical fingerprint sensor, and light of each of the two or more LED lights may be near-ultraviolet light, purple light, blue light, green light, yellow light, red light, near infrared light or white light. Light of each of the two or more LED lights may be the same or different, or light of some of the two or more LED lights may be the same, and light of some of the two or more LED lights may be different.

In the optical fingerprint module in the embodiment shown in FIGS. 1 and 2, the optical fingerprint sensor 110 includes only one non-opaque substrate 111, thus the light emitted by the point-shaped backlight source 120 only needs to pass through the device layer 112 and the one non-opaque substrate 111 when passing through the optical fingerprint sensor 110. Therefore, number of substrates the light passes through can be reduced, which is beneficial to form a clear fingerprint image; and the optical fingerprint sensor 110 has a simple structure and a reduced thickness, which can simplify the structure of the optical fingerprint module and reduce the cost. In addition, the point-shaped backlight source 120 and the optical fingerprint sensor 110 are disposed with an interval, and a right angle or a near-right angle is formed between the light emitted by the point-shaped backlight source 120 and the first surface of the non-opaque substrate 111, the light reaching the first surface can be mostly reflected with a small offset (or zero offset) at an interface between the first surface and a finger, and most of the effectively reflected light can irradiate to pixels closer to corresponding reflection points in the pixel region 1120. Therefore, using the optical fingerprint module without a light guiding plate, accurate fingerprint image recognition can be achieved, definition of the fingerprint images can be improved, a structure of the optical fingerprint module can be simplified and cost can be reduced.

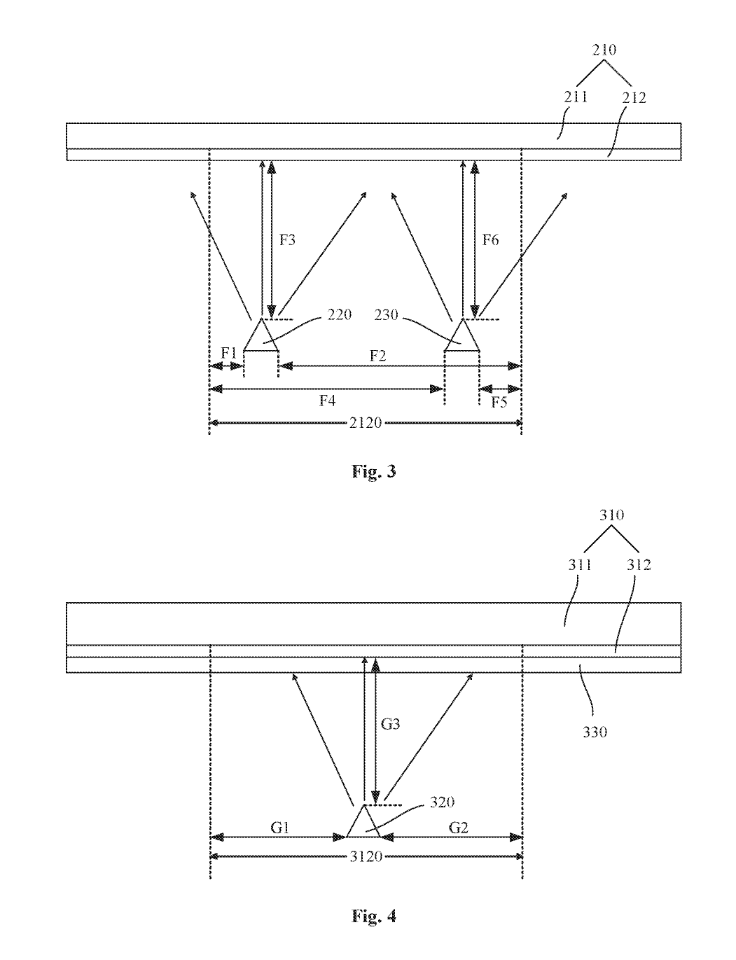

An optical fingerprint module is provided according to another embodiment. Referring to FIG. 3, FIG. 3 schematically illustrates a cross-sectional view of an optical fingerprint module according to another embodiment. The optical fingerprint module may include an optical fingerprint sensor 210 and a point-shaped backlight source (not shown).

In some embodiment, the optical fingerprint sensor 210 may include only one non-opaque substrate 211. A first surface (not shown) of the non-opaque substrate 211 may be used for fingerprint contact, and the optical fingerprint sensor 210 may further include a device layer 212 disposed on a second surface (not shown) of the non-opaque substrate 211. Specifically, as shown in FIG. 3, the first surface may be an upper surface of the non-opaque substrate 211, and the second surface may be a lower surface of the non-opaque substrate 211.

In some embodiment, the device layer 212 may include a pixel region 2120, the pixel region 2120 may include a plurality of pixels (not shown), each of the plurality of pixels may include a non-opaque region (not shown) and a light-blocking region (not shown), the light-blocking region may include a photosensitive device (not shown), and the non-opaque region allows light to pass through the pixel region 2120 of the device layer 212.

In some embodiment, the point-shaped backlight source may include two LED lights, i.e. a first LED light 220 and a second LED light 230 respectively.

In some embodiment, the first LED light 220 and the second LED light 230 may be disposed under the pixel region 2120, and there is a third distance F3 between the first LED light 220 and the optical fingerprint sensor 210, and a sixth distance F6 between the second LED light 230 and the optical fingerprint sensor 210. That is, the point-shaped backlight source is disposed right under the pixel region 2120, and the point-shaped backlight source and the optical fingerprint sensor 210 are disposed with an interval.

A right angle or a near-right angle is formed between the first LED light 220 and the first surface and between the second LED light 230 and the first surface. That is, a right angle or a near-right angle is formed between the light emitted from the point-shaped backlight source and the first surface.

Referring to FIG. 3, the light emitted by the first LED light 220 and the light emitted by the second LED light 230 are shown by black unidirectional arrows. The first LED light 220 and the second LED light 230 are disposed right below the pixel region 2120, and in a top view of FIG. 3, the first LED light 220 is disposed on a left side of the second LED light 230.

In the cross-sectional view shown in FIG. 3, in a horizontal direction, there is a first distance F1 between the first LED light 220 and a left edge of a region right under the pixel region 2120, and a second distance F2 between the first LED light 220 and a right edge of the region right under the pixel region 2120. In a vertical direction, there is a third distance F3 between the first LED light 220 and the optical fingerprint sensor 210. It can be seen from the above that, due to existence of the first distance F1, the second distance F2 and the third distance F3, the first LED light 220 may be necessarily disposed below the pixel region 2120.

In some embodiment, the first distance F1, the second distance F2 and the third distance F3 may be adjusted so that the first LED light 220 can be placed in an appropriate position, thereby improving definition of fingerprint images captured by the optical fingerprint module.

Similarly, as shown in FIG. 3, in a horizontal direction, there is a fourth distance F4 between the second LED light 230 and a left edge of a region right under the pixel region 2120, and a fifth distance F5 between the second LED light 230 and a right edge of the region right under the pixel region 2120. In a vertical direction, there is a sixth distance F6 between the second LED light 230 and the optical fingerprint sensor 210. It can be seen from the above that, due to the existence of the fourth distance F4, the fifth distance F5 and the sixth distance F6, the second LED light 230 may be necessarily disposed below the pixel region 2120.

In some embodiment, the fourth distance F4, the fifth distance F5 and the sixth distance F6 may be adjusted so that the second LED light 230 can be placed in an appropriate position, thereby improving definition of the fingerprint image captured by the optical fingerprint module.

In some embodiment, the light emitted by the first LED light 220 and the light emitted by the second LED light 230 may be near-ultraviolet light, purple light, blue light, green light, yellow light, red light, near infrared light or white light. The light of the two LED lights may be the same or different. It should be noted that, in other embodiments, the point-shaped backlight source may include three or more LED lights, and the three or more LED lights may be symmetrically and evenly distributed under the optical fingerprint sensor 210. For example, when the point-shaped backlight source includes four LED lights, and a top view of the pixel region 2120 is rectangle-shaped, the four LED lights may be symmetrically distributed under the pixel region 2120 and on four sides of a rectangular region right under the pixel region 2120. In other embodiments, light of each LED light may be near ultraviolet light, purple light, blue light, green light, yellow light, red light, near infrared light or white light. The light of each LED light may be the same or different, or light of some of the LED lights are the same, and light of some of the LED lights are different.

It should be noted that, when the point-shaped backlight source includes two or more LED lights, for example, when the point-shaped backlight source includes the first LED light 220 and the second LED light 230, a closest distance of all the distances between the pixel region 2120 and each of the LED lights may be taken as a distance between the point-shaped backlight source and the pixel region 2120.

Using the optical fingerprint module without a light guiding plate in the embodiment shown in FIG. 3, fingerprint image recognition can be achieved, clear fingerprint images can be captured, a structure of the optical fingerprint module can be simplified and cost can be reduced. Further, the point-shaped backlight source includes the first LED light 220 and the second LED light 230, during fingerprint image capturing, any one of the two LED lights may be selected as an imaging light source of a fingerprint image, or light emitted from the two LED lights may be used in turn for imaging, and afterward, calculations like noise reduction and compensation and so on may be performed, so as to obtain a fingerprint image with higher definition and higher accuracy, and further to improve performance of the optical fingerprint module.

In other embodiments, when the point-shaped backlight source includes three or more LED lights, light emitted by the three or more LED lights may be used alternately for imaging, and afterward, calculations like noise reduction and compensation and so on may be performed, so as to obtain a fingerprint image with higher definition and accuracy, and further to improve performance of the optical fingerprint module.

For more information on structure and properties of the optical fingerprint module in the embodiment shown in FIG. 3, reference may be made to the corresponding descriptions of the optical fingerprint modules in the aforementioned embodiments shown in FIGS. 1 and 2.

An optical fingerprint module is provided according to another embodiment of the present disclosure. Referring to FIG. 4, FIG. 4 schematically illustrates a cross-sectional view of an optical fingerprint module according to another embodiment. The optical fingerprint module may include an optical fingerprint sensor 310 and a point-shaped backlight source 320.

Referring to FIG. 4, the optical fingerprint sensor 310 may include only one non-opaque substrate 311. A first surface (not shown) of the non-opaque substrate 311 may be directly used for fingerprint contact, and the optical fingerprint sensor 310 may further include a device layer 312 disposed on a second surface (not shown) of the non-opaque substrate 311. Specifically, as shown in FIG. 4, the first surface may be an upper surface of the non-opaque substrate 311, and the second surface may be a lower surface of the non-opaque substrate 311.

In some embodiment, the device layer 312 may include a pixel region 3120. The pixel region 3120 may include a plurality of pixels (not shown), and each of the plurality of pixels may include a non-opaque region (not shown) and a light blocking region (not shown), where the light blocking region may include a photosensitive device (not shown), and the non-opaque region allows light to pass through the pixel region 3120 of the device layer 312.

In some embodiment, the point-shaped backlight source 320 may be disposed below the pixel region 3120, and the point-shaped backlight source 320 and the optical fingerprint sensor 310 may be disposed with an interval, i.e., there is a third distance G3 between the point-shaped backlight source 320 and a lower surface of the device layer 312 of the optical fingerprint sensor 310. A right angle or a near-right angle may be formed between the light emitted from the point-shaped backlight source 320 and the first surface of the non-opaque substrate 311. Specifically, the point-shaped backlight source 320 may be disposed right under the pixel region 3120 so as to ensure formation of the right angle or the near-right angle.

In some embodiment, the point-shaped backlight source 320 may include a LED light. Light emitted from the point-shaped backlight source 320 is shown by black unidirectional arrows in FIG. 4. The point-shaped backlight source 320 may be disposed right under the pixel region 3120. In the cross-sectional view shown in FIG. 4, in a horizontal direction, there is a first distance G1 between a left edge of a region right under the pixel region 3120 and the point-shaped backlight source 320, and a second distance G2 between a right edge of a region right under the pixel region 3120 and the point-shaped backlight source 320. In a vertical direction, there is a third distance G3 between the point-shaped backlight source 320 and a lower surface of the device layer 312. It can be seen from the above that, due to the existence of the first distance G1, the second distance G2 and the third distance G3, the point-shaped backlight source 320 may be necessarily disposed right under the pixel region 3120.

In some embodiment, the point-shaped backlight source 320 can be placed in an appropriate position by adjusting the first distance G1, the second distance G2 and the third distance G3, so as to improve definition of fingerprint images captured by the optical fingerprint module.

Referring to FIG. 4, in some embodiments, the optical fingerprint module may further include a light anti-reflection layer 330 disposed on a surface of the optical fingerprint sensor 310 closer to the point-shaped backlight source 320, where the light anti-reflection layer 330 is configured to increase a proportion of light emitted from the point-shaped backlight source 320 which enters the optical fingerprint sensor 310.

In some embodiment, the light anti-reflection layer 330 is directly disposed on a surface of the device layer 312 so as to reduce a thickness of the optical fingerprint module.

In the embodiment shown in FIG. 4, using the optical fingerprint module without a light guiding plate, fingerprint image recognition can be achieved, clear fingerprint images can be captured, a structure of the optical fingerprint module can be simplified and cost can be reduced. In addition, a surface of the optical fingerprint sensor 310 close to the point-shaped backlight source 320 further includes a light anti-reflection layer 330, where the light anti-reflection layer 330 can increase a proportion of the light of the point-shaped backlight 320 entering the optical fingerprint sensor 310. Therefore, more light can be used for fingerprint image capturing, so as to obtain fingerprint images with higher definition and higher accuracy and further to improve performance of the optical fingerprint module.

For more information on the structure and properties of the optical fingerprint module in the embodiment shown in FIG. 4, reference may be made to the corresponding descriptions of the optical fingerprint modules in the aforementioned embodiments.

An optical fingerprint module is provided according to another embodiment of the present disclosure. Referring to FIG. 5. FIG. 5 schematically illustrates a cross-sectional view of an optical fingerprint module according to another embodiment. The optical fingerprint module may include an optical fingerprint sensor 410 and a point-shaped backlight source 420.

In some embodiment, the optical fingerprint sensor 410 may include only one non-opaque substrate 411. A first surface (not shown) of the non-opaque substrate 411 may be directly used for fingerprint contact, and the optical fingerprint sensor 410 may further include a device layer 412 disposed on a second surface (not shown) of the non-opaque substrate 411. Specifically, as shown in FIG. 5, the first surface may be an upper surface of the non-opaque substrate 411, and the second surface may be a lower surface of the non-opaque substrate 411.

In some embodiment, the device layer 412 may include a pixel region 4120. The pixel region 4120 may include a plurality of pixels (not shown), and each of the plurality of pixels may include a non-opaque region (not shown) and a light blocking region (not shown), where the light blocking region may include a photosensitive device (not shown), and the non-opaque region allows light to pass through the pixel region 4120 of the device layer 412.

In some embodiment, the point-shaped backlight source 420 may be disposed below the pixel region 4120, and the point-shaped backlight source 420 and the optical fingerprint sensor 410 may be disposed with an interval (i.e., a third distance G3). A right angle or a near-right angle may be formed between the light emitted from the point-shaped backlight source 420 and the first surface of the non-opaque substrate 411. Specifically, the point-shaped backlight source 420 may be disposed right under the pixel region 4120 so as to ensure formation of the right angle or the near-right angle.

In some embodiment, the point-shaped backlight source 420 may include a LED light. Light emitted from the point-shaped backlight source 420 is shown by black unidirectional arrows in FIG. 5. In the cross-sectional view shown in FIG. 5, in a horizontal direction, there is a first distance H1 between a left edge of a region right under the pixel region 4120 and the point-shaped backlight source 420, and a second distance H2 between a right edge of a region right under the pixel region 4120 and the point-shaped backlight source 420. In a vertical direction, there is a third distance H3 between the point-shaped backlight source 420 and a lower surface of the device layer 412. It can be seen from the above that, due to the existence of the first distance H1, the second distance H2 and the third distance H3, the point-shaped backlight source 420 may be necessarily disposed right under the pixel region 4120.

In some embodiment, the point-shaped backlight source 420 can be placed in an appropriate position by adjusting the first distance H1, the second distance H2 and the third distance H3, so as to improve definition of fingerprint images captured by the optical fingerprint module.

In some embodiment, the optical fingerprint module may further include a light focusing lens 430 in front of the point-shaped backlight source 420. The light focusing lens 430 can convert light of the point-shaped backlight source 420 into parallel light or near-parallel light. The light of the point-shaped backlight source 420 enters the light focusing lens 430, and then enters the optical fingerprint sensor 410.

It should be noted that, the near-parallel light means that a maximum angle difference between all the light rays is within 10 degrees.

In some embodiment, the light focusing lens 430 may be a convex lens, when a distance between the point-shaped backlight source 420 and the light focusing lens 430 is exactly equal to a focal length of the convex lens, the light passing through the light focusing lens 430 can be converted into parallel light. In other embodiments, the light focusing lens 430 may also be other suitable lenses, such as a Fresnel lens.

In the embodiment shown in FIG. 5, using the optical fingerprint module without a light guiding plate, fingerprint image recognition can be achieved, clear fingerprint images can be captured, a structure of the optical fingerprint module can be simplified and cost can be reduced. In addition, a light focusing lens 430 is disposed in front of a point-shaped backlight source 420 and configured to convert the light emitted from the point-shaped backlight source 420 into parallel light or near-parallel light. The light emitted from the point-shaped backlight source 420 enters the light focusing lens 430, and then enters the optical fingerprint sensor 410. Therefore, the parallel light or the near-parallel light can be used for fingerprint images capturing, so that the fingerprint images with less distortion and higher accuracy can be obtained, and performance of the optical fingerprint module can be further improved.

For more information on the structure and properties of the optical fingerprint module in the embodiment shown in FIG. 5, reference may be made to the corresponding descriptions of the optical fingerprint modules in the aforementioned embodiments.

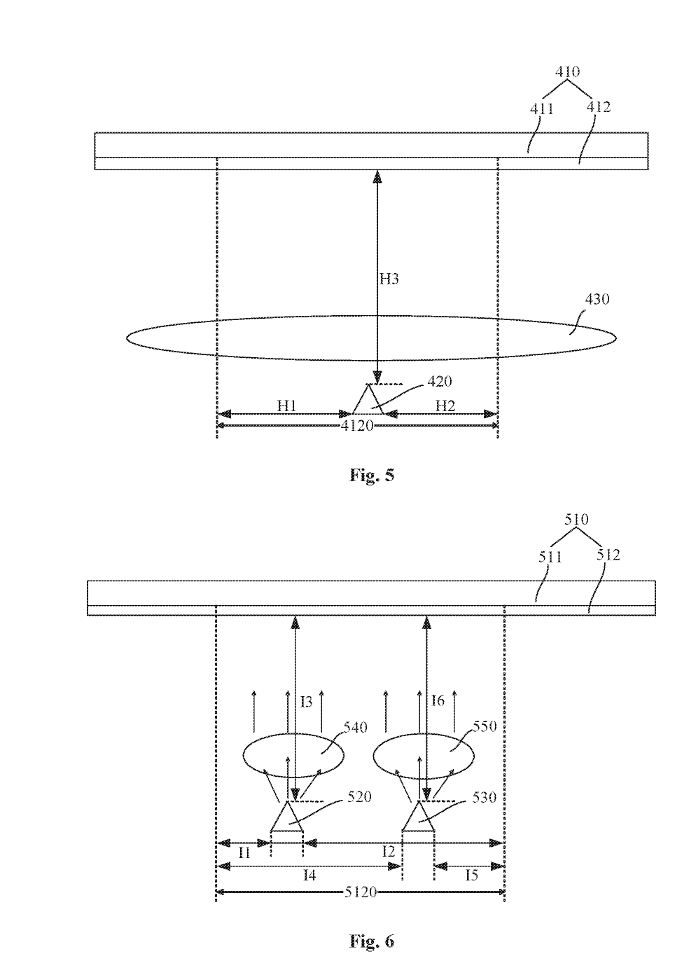

An optical fingerprint module is provided according to another embodiment of the present disclosure. Referring to FIG. 6, FIG. 6 schematically illustrates a cross-sectional view of an optical fingerprint module according to another embodiment. The optical fingerprint module may include an optical fingerprint sensor 510 and a point-shaped backlight source (not shown).

In some embodiment, the optical fingerprint sensor 510 may include only one non-opaque substrate 511. A first surface (not shown) of the non-opaque substrate 511 is directly used for fingerprint contact, and the optical fingerprint sensor 510 may further include a device layer 512 disposed on a second surface (not shown) of the non-opaque substrate 511. Specifically, as shown in FIG. 6, the first surface may be an upper surface of the non-opaque substrate 511, and the second surface may be a lower surface of the non-opaque substrate 511.

In some embodiment, the device layer 512 may include a pixel region 5120. The pixel region 5120 may include a plurality of pixels (not shown), each of the plurality of pixels may include a non-opaque region (not shown) and a light blocking region (not shown), where the light blocking region may include a photosensitive device (not shown) and the non-opaque region allows light to pass through the pixel region 5120 of the device layer 512.

In some embodiment, the point-shaped backlight source may be disposed below the pixel region 5120, and a right angle or a near-right angle may be formed between the light emitted from the point-shaped backlight source and the first surface of the non-opaque substrate 511. Specifically, the point-shaped backlight source may be disposed right under the pixel region 5120.

In some embodiment, the point-shaped backlight source may include a first LED light 520 and a second LED light 530 disposed under the pixel region 5120. A right angle or a near-right angle may be formed between the light emitted from the first LED light 520 and an upper surface of the first surface, and between the second LED light 530 and the upper surface of the first surface.

In the cross-sectional view shown in FIG. 6, in a horizontal direction, there is a first distance I1 between the first LED light 520 and a left edge of a region right under the pixel region 5120, and a second distance I2 between the first LED light 520 and a right edge of the region right under the pixel region 5120. In a vertical direction, there is a third distance I3 between the first LED light 520 and a lower surface of the device layer 512. It can be seen from the above that, due to the existence of the first distance I1, the second distance I2 and the third distance I3, the first LED light 520 may be necessarily disposed below the pixel region 5120.

In some embodiment, the first LED light 520 may be placed in an appropriate position by adjusting the first distance I1, the second distance I2 and the third distance I3, so as to improve definition of fingerprint images captured by the optical fingerprint module.

Similarly, in the cross-sectional view shown in FIG. 6, in a horizontal direction, there is a fourth distance I4 between the second LED light 530 and a left edge of a region right under the pixel region 5120, and a fifth distance I5 between the second LED light 530 and a right edge of the region right under the pixel region 5120. In a vertical direction, there is a sixth distance I6 between the second LED light 530 and a lower surface of the device layer 512. It can be seen from the above that, due to existence of the fourth distance I4, the fifth distance I5 and the sixth distance I6, the second LED light 530 may be necessarily disposed below the pixel region 5120.

A sum of the fourth distance I4, the fifth distance I5 and a width of the LED light 530 is always equal to one side length of the pixel region 5120 (referring to a side length E1 in FIG. 1). In some embodiment, the second LED light 530 may be disposed in an appropriate position by adjusting the fourth distance I4, the fifth distance I5 and the sixth distance I6, so as to improve definition of fingerprint images captured by the optical fingerprint module.

Different from the aforementioned embodiments, in the embodiment shown in FIG. 6, a first light focusing lens 540 may be disposed between the first LED light 520 and the optical fingerprint sensor 510, and a second light focusing lens 550 may be disposed between the second LED light 530 and the optical fingerprint sensor 510. That is, a first light focusing lens 540 may be disposed in front of a light emitting surface of the first LED light 520, and the first light focusing lens 540 may be configured to convert light emitted from the first LED light 520 into parallel light or near-parallel light. The light emitted from the first LED light 520 enters the first light focusing lens 540 and then enters the optical fingerprint sensor 510. The second light focusing lens 550 may be disposed in front of a light emitting surface of the second LED light 530, and the second light focusing lens 550 may be configured to convert light emitted from the second LED light 530 into parallel light or near-parallel light. The light emitted from the second LED light 530 enters the second light focusing lens 550 and then enters the optical fingerprint sensor 510.

Using the optical fingerprint module without a light guiding plate in the embodiment shown in FIG. 6, fingerprint image recognition can be achieved, clear fingerprint images can be captured, a structure of the optical fingerprint module can be simplified and cost can be reduced. In addition, the first light focusing lens 540 and the second light focusing lens 550 are disposed in front of the light emitting surface of the first LED light 520 and the light emitting surface of the second LED light 530 respectively, and the first light focusing lens 540 and the second light focusing lens 550 can respectively convert the light of the first LED light 520 and the light of the second LED light 530 into parallel light or near-parallel light, the light of the first LED light 520 and the light of the second LED light 530 enters a corresponding light focusing lens respectively and then enters the optical fingerprint sensor 510. Therefore, during the fingerprint image capturing, fingerprint images can be captured by parallel light or near-parallel light, so as to obtain fingerprint images with smaller distortion and higher accuracy and further to improve performance of the optical fingerprint module.

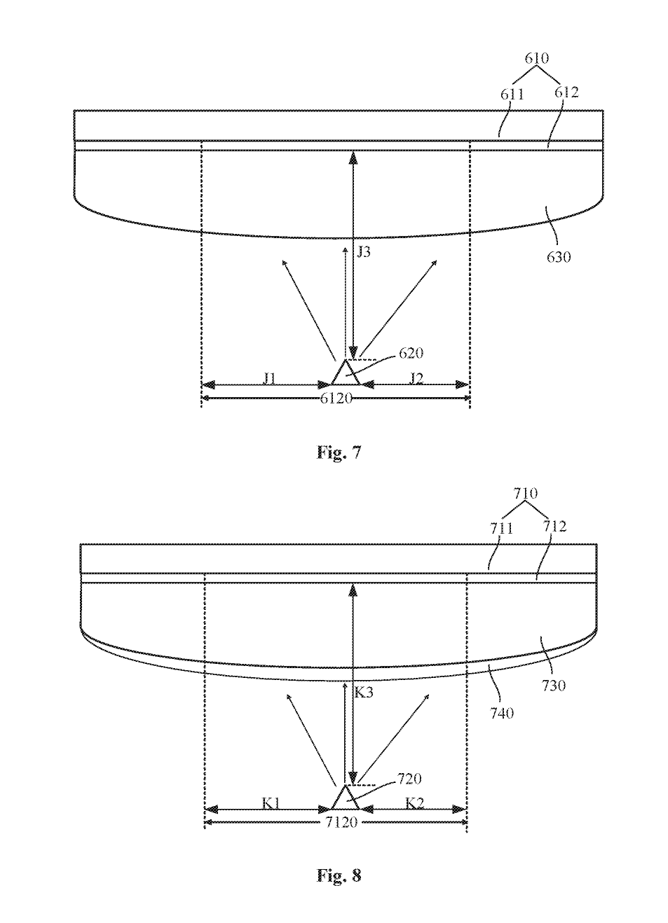

An optical fingerprint module is provided according to another embodiment of the present disclosure. Referring to FIG. 7, FIG. 7 schematically illustrates a cross-sectional view of an optical fingerprint module according to another embodiment. The optical fingerprint module may include an optical fingerprint sensor 610 and a point-shaped backlight source 620.

Referring to FIG. 7, the optical fingerprint sensor 610 may include only one non-opaque substrate 611. A first surface (not shown) of the non-opaque substrate 611 may be directly used for fingerprint contact. A second surface (not shown) of the non-opaque substrate 611 may include a device layer 612. Specifically, as shown in FIG. 7, the first surface is an upper surface of the non-opaque substrate 611, and the second surface is a lower surface of the non-opaque substrate 611.

In some embodiment, the device layer 612 may include a pixel region 6120. The pixel region 6120 may include a plurality of pixels (not shown), each of the plurality of pixels may include a non-opaque region (not shown) and a light blocking region (not shown), where the light blocking region may include a photosensitive device (not shown), and the non-opaque region allows light to pass through the pixel region 6120 of the device layer 612.

In some embodiment, the point-shaped backlight source 620 may be disposed under the pixel region 6120, the point-shaped backlight source 620 and the optical fingerprint sensor 610 may be disposed with an interval, i.e., a third distance J3, and a right angle or a near-right angle may be formed between light emitted from the point-shaped backlight source 620 and the first surface of the non-opaque substrate 611. Specifically, the point-shaped backlight source 620 may be disposed right under the pixel region 6120 so as to ensure formation of the right angle or the near-right angle.

Light emitted by the point-shaped backlight source 620 is shown by black unidirectional arrows in FIG. 7. In the cross-sectional view shown in FIG. 7, in a horizontal direction, there is a first distance J1 between a left edge of a region right under the pixel region 6120 and the point-shaped backlight source 620, and a second distance J2 between a right edge of the region right under the pixel region 6120 and the point-shaped backlight source 620. In a vertical direction, there is a third distance J3 between the point-shaped backlight source 620 and a lower surface of the device layer 612. It can be seen from the above that, due to the existence of the first distance J1, the second distance J2 and the third distance J3, the point-shaped backlight source 620 may be necessarily disposed right under the pixel region 6120.

In some embodiment, the point-shaped backlight source 620 can be placed in an appropriate position by adjusting the first distance J1, the second distance J2 and the third distance J3, so as to improve definition of fingerprint images captured by the optical fingerprint module.

Different from the aforementioned embodiments, in the embodiment as shown in FIG. 7, the optical fingerprint module may further include a non-opaque dielectric layer 630 disposed between the optical fingerprint sensor 610 and the point-shaped backlight source 620, where light emitted from the point-shaped backlight source 620 enters the non-opaque dielectric layer 630 and then enters the optical fingerprint sensor 610. The non-opaque dielectric layer 630 has a refractive index greater than air, and a lower surface of the non-opaque dielectric layer 630 is a light focusing surface (not shown). The light focusing surface of the non-opaque dielectric layer 630 can convert light of the point-shaped backlight source 620 into parallel light or near-parallel light, and the light of the point-shaped backlight source 620 enters the non-opaque dielectric layer 630 and then enters the optical fingerprint sensor 610. Therefore, parallel light or near-parallel light can be used to capture fingerprint images, so as to obtain fingerprint images with smaller distortion and higher accuracy, and further to improve performance of the optical fingerprint module.

It should be noted that, although the optical fingerprint module includes the non-opaque dielectric layer 630, the optical fingerprint sensor 610 itself includes only one non-opaque substrate 611. The optical fingerprint sensor 610 still has a simplified structure. That is, the non-opaque dielectric layer 630 is a structure disposed between the optical fingerprint sensor 610 and the point-shaped backlight source 620 and does not belong to a part of the optical fingerprint sensor 610.

In some embodiment, the non-opaque dielectric layer 630 may have a refractive index equal to or greater than 1.2, so as to further improve performance of the optical fingerprint module.

In some embodiment, the non-opaque dielectric layer 630 may be made of glass, plastic or optical glue.

In some embodiment, the light focusing surface of the non-opaque dielectric layer 630 may be an ellipsoidal crown surface. In other embodiments, the light focusing surface of the non-opaque dielectric layer 630 may be an oblique surface, a spherical crown surface, a conical side surface or a pyramid side surface and so on.

It should be noted that, although not shown in FIG. 7, in some embodiment, a second optical adhesive layer may be disposed between the optical fingerprint sensor 610 and the non-opaque dielectric layer 630, where the light emitted from the point-shaped backlight source 620 enters the second optical adhesive layer from the non-opaque dielectric layer 630, and then enters the optical fingerprint sensor 610 from the second optical adhesive layer. The second optical adhesive layer may avoid existence of air between the optical fingerprint sensor 610 and the non-opaque dielectric layer 630, so as to prevent the light from being scattered and refracted at an interface between the air and the optical fingerprint sensor 610 or at an interface between the air and the non-opaque dielectric layer 630, which can improve quality of fingerprint images.

For more information about the structure and properties of the optical fingerprint module in the embodiment shown in FIG. 7, reference may be made to corresponding descriptions of the optical fingerprint modules in the aforementioned embodiments.

An optical fingerprint module is provided according to another embodiment of the present disclosure. Referring to FIG. 8, FIG. 8 schematically illustrates a cross-sectional view of an optical fingerprint module according to another embodiment. The optical fingerprint module may include an optical fingerprint sensor 710 and a point-shaped backlight source 720.

In some embodiment, the optical fingerprint sensor 710 may include only one non-opaque substrate 711. A first surface (not shown) of the non-opaque substrate 711 may) be directly used for fingerprint contact, and the optical fingerprint sensor 710 may further include a device layer 712 disposed on a second surface (not shown) of the non-opaque substrate 711. Specifically, as shown in FIG. 8, the first surface may be an upper surface of the non-opaque substrate 711, and the second surface may be a lower surface of the non-opaque substrate 711.

In some embodiment, the device layer 712 may include a pixel region 7120, the pixel region 7120 may include a plurality of pixels (not shown), each of the plurality of pixels may include a non-opaque region (not shown) and a light-blocking region (not shown), the light-blocking region may include a photosensitive device (not shown), and the non-opaque region allows light to pass through the pixel region 7120 of the device layer 712.

In some embodiment, the point-shaped backlight source 720 may be disposed below the pixel region 7120, and the point-shaped backlight source 720 and the optical fingerprint sensor 710 may be disposed with an interval, i.e., there is a third distance K3 between the point-shaped backlight source 720 and a lower surface of the device layer 712 of the optical fingerprint sensor 710. A right angle or a near-right angle may be formed between the light emitted from the point-shaped backlight source 720 and the first surface of the non-opaque substrate 711. Specifically, the point-shaped backlight source 720 may be disposed right under the pixel region 7120, so as to ensure formation of the right angle or the near-right angle.

The light emitted from the point-shaped backlight source 720 is represented by black unidirectional arrows as shown in FIG. 8. In the cross-sectional view, in a horizontal direction, there is a first distance K1 between a left edge of a region right under the pixel region 7120 and the point-shaped backlight source 720, and a second distance K2 between a right edge of the region right under the pixel region 7120 and the point-shaped backlight source 720. In a vertical direction, there is a third distance K3 between the point-shaped backlight source 720 and a lower surface of the device layer 712. From above, it can be seen that, due to existence of the first distance K1, the second distance K2 and the third distance K3, the point-shaped backlight source 620 is necessarily disposed right under the pixel region 6120.

In some embodiment, the point-shaped backlight source 620 may be placed in an appropriate position by adjusting the first distance K1, the second distance K2 and the third distance K3, so as to improve definition of fingerprint images captured by the optical fingerprint module.

In some embodiment, the optical fingerprint module may further include a non-opaque dielectric layer 730 disposed between the optical fingerprint sensor 710 and the point-shaped backlight source 720, where light emitted from the point-shaped backlight source 720 enters the non-opaque dielectric layer 730 and then enters the optical fingerprint sensor 710.

In some embodiment, the non-opaque dielectric layer 730 may have a refractive index above 1.2, so as to further improve performance of the optical fingerprint module. Specifically, the non-opaque dielectric layer 730 may be made of glass, plastic or optical glue.

In some embodiment, a lower surface of the non-opaque dielectric layer 730 may be a light focusing surface (not shown), and the light emitted from the point-shaped backlight source 720 enters the non-opaque dielectric layer 730 from the light focusing surface, and the light focusing surface may convert the light emitted from the point-shaped backlight source 720 into parallel light or near-parallel light.

In some embodiment, the optical fingerprint module may further include a light anti-reflection layer 740 disposed on the light focusing surface (i.e., the lower surface of the non-opaque dielectric layer 730), where the light anti-reflection layer 740 can increase a proportion of the light of the point-shaped backlight source 720 entering the non-opaque dielectric layer. Therefore, the fingerprint images may be captured using more light, so that the fingerprint images with higher definition and higher accuracy can be obtained, and performance of the optical fingerprint module can be further improved.

More information on the structure and properties of the optical fingerprint module according to the embodiment shown in FIG. 8 may be referred to corresponding descriptions of the optical fingerprint modules in the aforementioned embodiments.

Although the present disclosure has been described above, the present disclosure is not limited thereto. It should be understood by those skilled in the art that various changes and modifications may be made without departing from the spirit and scope of the disclosure, and therefore, the scope of the disclosure should be limited by the scope of the claims.

What is claimed is:

1. An optical fingerprint module comprising:
an optical fingerprint sensor; and
a point-shaped backlight source;
wherein the optical fingerprint sensor comprises only one non-opaque substrate;
a first surface of the non-opaque substrate is directly used for fingerprinting contact;
a device layer is disposed on a second surface of the non-opaque substrate;
the device layer comprises a pixel region, the pixel region comprises a plurality of pixels, each of the plurality of pixels comprises a non-opaque region and a light blocking region, the light blocking region comprises a photosensitive device, and the non-opaque region allows light to pass through the pixel region of the device layer; and
the point-shaped backlight source is disposed right under the pixel region, the point-shaped backlight source and the optical fingerprint sensor are disposed with an interval, and a right angle or a near-right angle is formed between light emitted from the point-shaped backlight source and the first surface of the non-opaque substrate.

2. The optical fingerprint module according to claim 1, wherein the point-shaped backlight source is disposed under the device layer, and an output light of the point-shaped backlight source passes through the device layer from the non-opaque region and then enters the non-opaque substrate.

3. The optical fingerprint module according to claim 1, wherein each of the plurality of pixels further comprises a light blocking layer, the photosensitive device is disposed between the light blocking layer and the non-opaque substrate, and the light blocking layer is disposed between the photosensitive device and the point-shaped backlight source.

4. The optical fingerprint module according to claim 1, wherein the point-shaped backlight source comprises at least one Light Emitting Diode (LED) light, light of the at least one LED light is at least one of near ultraviolet light, purple light, blue light, green light, yellow light, red light, near infrared light or white light; or, the point-shaped backlight source comprises two or more LED lights, the two or more LED lights are symmetrically distributed under the optical fingerprint sensor, and light of the two or more LED lights is at least one of near-ultraviolet light, purple light, blue light, green light, yellow light, red light, near infrared light or white light.

5. The optical fingerprint module according to claim 1, further comprising: a light focusing lens disposed in front of a light emitting surface of the point-shaped backlight source, wherein the light focusing lens is configured to convert light of the point-shaped backlight source into parallel light or near-parallel light, and the light emitted from the point-shaped backlight source enters the light focusing lens and then enters the optical fingerprint sensor.

6. The optical fingerprint module according to claim 1, further comprising: a light anti-reflection layer disposed on a surface of the device layer and configured to increase a proportion of light emitted from the point-shaped backlight source which enters the optical fingerprint sensor.

7. The optical fingerprint module according to claim 1, further comprising: a non-opaque dielectric layer disposed between the optical fingerprint sensor and the point-shaped backlight source, wherein light emitted from the point-shaped backlight source enters the non-opaque dielectric layer and then enters the optical fingerprint sensor.

8. The optical fingerprint module according to claim 7, wherein a lower surface of the non-opaque dielectric layer is a light focusing surface, the light emitted from the point-shaped backlight source enters the non-opaque dielectric layer from the light focusing surface, and the light focusing surface is configured to convert the light emitted from the point-shaped backlight source into parallel light or near-parallel light.

9. The optical fingerprint module according to claim 7, further comprising: a light anti-reflection layer disposed on the lower surface of the non-opaque dielectric layer and configured to increase a proportion of the light emitted from the point-shaped backlight source which enters the non-opaque dielectric layer.

10. The optical fingerprint module according to claim 8, wherein the non-opaque dielectric layer is made of at least one of glass, plastic or optical adhesive; and the light focusing surface of the non-opaque dielectric layer is at least one of an oblique surface, a spherical crown surface, an ellipsoidal crown surface, a conical side surface or a pyramid side surface.

11. The optical fingerprint module according to claim 7, wherein the non-opaque dielectric layer has a refraction index above 1.2.

12. The optical fingerprint module according to claim 1, further comprising a light filtering layer disposed on at least one of the first surface and the second surface of the non-opaque substrate.
